(19) United States
(12) Patent Application Publication
(10) Pub. No.: US 2022/0063010 A1
(43) Pub. Date: Mar. 3, 2022

(54) WELDING-TYPE POWER SUPPLIES WITH JOB SPECIFIC WELD MONITORING SYSTEMS

(71) Applicant: Illinois Tool Works Inc., Glenview, IL (US)

(72) Inventor: Jake Bradley Zwayer, Appleton, WI (US)

(21) Appl. No.: 17/404,107

(22) Filed: Aug. 17, 2021

Related U.S. Application Data
(60) Provisional application No. 63/072,637, filed on Aug. 31, 2020.

(51) Int. Cl. B23K 9/095; B23K 9/10; B23K 9/173; B23K 9/025

(52) U.S. Cl. CPC B23K 9/0956; B23K 9/0953; B23K 9/025; B23K 9/173; B23K 9/1062

(57) ABSTRACT

Systems and methods for tracking and associating welding-type data with selected welding jobs. A welding job from a plurality of welding jobs stored in memory of a welding-type power supply may be selected, and welding-type data collected while a particular welding jobs is selected is associated in memory with the selected welding job. Welding-type data associated with the plurality of welding jobs may be displayed and managed.

### CROSS-REFERENCE TO RELATED APPLICATIONS

The present application claims priority to, and the benefit of, U.S. Provisional Patent Application No. 63/072,637, entitled “WELDING-TYPE POWER SUPPLIES WITH JOB TRACKING,” filed Aug. 31, 2020, the entire contents of which are hereby incorporated by reference.

### TECHNICAL FIELD

The present disclosure generally relates to weld monitoring systems for welding-type power supplies and, more particularly, to welding-type power supplies with job specific weld monitoring systems.

### BACKGROUND

Welding-type power supplies are used to provide power for welding-type operations, such as welding and plasma cutting. The power supplies are often portable, allowing them to be transported to (and/or used at) different job sites.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to welding-type power supplies with job tracking, substantially as illustrated by and/or described in connection with at least one of the figures, and as set forth more completely in the claims.

### BRIEF DESCRIPTION OF THE DRAWINGS

FIG. 1 shows an example welding system including a welding-type power supply configured to monitor for and collect welding-type data and associate collected welding-type data with selected welding jobs, in accordance with aspects of this disclosure.

FIG. 2 is a block diagram of the welding system of FIG. 1, in accordance with aspects of this disclosure.

FIG. 3 shows an example interface for displaying and managing welding jobs and welding-type data associated with welding jobs, in accordance with aspects of this disclosure.

FIG. 4 shows an example interface for estimating welding-type data associated with the completion of a welding job, in accordance with aspects of this disclosure.

FIG. 5 is a flow diagram illustrating an example method of monitoring and collecting welding-type data and associating the collected welding-type data with selected welding jobs, in accordance with aspects of this disclosure.

The figures are not necessarily to scale. Where appropriate, the same or similar reference numerals are used in the figures to refer to similar or identical elements.

### DETAILED DESCRIPTION

Some examples of the present disclosure relate to welding-type power supplies with job specific weld monitoring systems. Weld monitoring systems are sometimes used to monitor and/or track data associated with welding-type tasks/operations (i.e., welding-type date). In some examples, the data may be collected via one or more sensors of a welding-type system and/or via operator input. Conventional weld monitoring systems, however, may not differentiate between welding-type data relating to one job or another.

In some examples, a particular welding-type power supply may be used at (and/or for) two or more different welding jobs contemporaneously (e.g., at two or more different job sites and/or for two or more different job specific tasks). In such examples, the operator(s) may switch back and forth between using the particular welding-type power supply at (and/or for) one welding job or another before the completion of either welding job. It may therefore be desirable to track the welding-type data on a per job basis.

The present disclosure contemplates a welding-type power supply that tracks and associates welding-type data for one welding job separately from welding-type data for a different welding job, as the welding-type data is collected. For example, an operator may select a welding job, or a specific welding job may be automatically selected (e.g., based on a detected location, configuration, operator, etc.), and welding-type data that is subsequently collected may be associated in memory with the selected welding job. If the welding-type power supply is then used for a different welding job, that different welding job may then be selected (manually or automatically), and welding-type data subsequently collected may be associated with that different welding job.

By organizing the monitored welding-type data according to welding jobs when collecting the monitored data, it becomes possible to view and/or analyze the monitored welding-type data according to each job during the job and/or after the job is over. For example, a user may be able to determine how much time, material, and/or other resources were spent to complete the job, which may be used for billing, accounting, quality assurance, performance review, future planning, etc. Further, a user may be able to determine how much time, material, and/or other resources have been spent on a job to a certain point in the job in order to plan how much additional time, material, and/or other resources will be required complete the job.

In some examples, the weld monitoring system may estimate a completion percentage of the job while the job is ongoing. For example, the job may be estimated to require a certain amount of one or more job parameters (e.g., man hours, arc or welding time, number of welds, amount of deposition material, etc.). In such an example, the distributed weld monitoring system may be able to estimate a completion percentage based on a comparison of the estimated job requirement(s) and the recorded job data.

In some examples, an operator may associate specific identifiers (e.g., names, numbers) with each of the plurality of welding jobs. In some examples, the welding-type data may be communicated to an external computing device, such as a smart phone, tablet, personal computer, a server, etc.

Disclosed example welding-type power supplies include power conversion circuitry configured to receive input power and convert the input power to welding-type power for a welding-type application; one or more sensors configured to sense welding-type data of the welding-type application; and processing circuitry configured to: associate the welding-type data with a first selected welding job of a plurality of welding jobs; and store in memory the welding-type data associated with the first selected welding job.

Some example welding-type power supplies further include a user interface configured to enable an operator to select the first selected welding job from the plurality of welding jobs.

In some example welding-type power supplies, the user interface is configured to enable an operator to apply a unique identifier to each of the plurality of welding jobs.

In some example welding-type power supplies, the user interface is configured to enable an operator to manage the plurality of welding jobs.

In some example welding-type power supplies, the user interface is configured to reset the welding-type data associated with the first selected welding job.

In some example welding-type power supplies, the user interface is configured to enable the operator to select a second selected welding job from the plurality of welding jobs, and the processing circuitry is configured to associate the welding-type data with the second selected welding job after the operator selects the second selected welding job.

In some example welding-type power supplies, the user interface is configured to enable the operator to subsequently select the first selected welding job from the plurality of welding jobs after the operator selected the second selected welding job, and the processing circuitry is configured to associate the welding-type data with the first selected welding job after the operator subsequently selected the first selected welding job.

In some example welding-type power supplies, the user interface is configured to display welding-type data associated with each of the plurality of welding jobs.

In some example welding-type power supplies, the processing circuitry is configured to associate the welding-type data with costs, and the user interface is configured to display costs associated with each of the plurality of welding jobs.

Some example welding-type power supplies further include communications circuitry configured to communicate with an external computing device, and wherein the communications circuitry is configured to receive a signal indicating a selection of the first selected welding job of the plurality of welding jobs from the external computing device.

Some example welding-type power supplies further include communications circuitry configured to communicate welding-type data associated with each of the plurality of welding jobs to an external computing device.

In some example welding-type power supplies, the processing circuitry is configured to associate the welding-type data with costs, and the communications circuitry is configured to communicate the cost data associated with each of the plurality of welding jobs to the external computing device.

In some example welding-type power supplies, the welding-type data includes at least one of an amperage of the welding device, a voltage of the welding device, a wire feed speed of the welding device, a shielding gas usage, an arc count, an arc time, a consumable cost, a usage time, a system power on time, an auxiliary power usage time, or a wire deposition weight.

Some example welding-type power supplies further include an engine and a generator configured to provide electrical power to the power conversion circuitry, and the welding-type data comprises a fuel usage.

Some example welding-type power supplies further include an auxiliary power output, and the welding-type data comprises data associated with the auxiliary power output.

In some example welding-type power supplies, the first welding job is automatically selected based on a detected location of the welding-type power supply.

In some example welding-type power supplies, the first welding job is automatically selected based on a detected configuration of the welding-type power supply.

In some example welding-type power supplies, the first welding job is automatically selected based on the welding-type data.

In some example welding-type power supplies, the first welding job is automatically selected based on an operator.

Disclosed example welding-type power supplies include power conversion circuitry configured to receive input power and convert the input power to welding-type power for a welding-type application; one or more sensors configured to sense welding-type data of the welding-type application; a user interface configured to enable an operator to select a first welding job from a plurality of welding jobs and a second welding job from the plurality of welding jobs; and processing circuitry configured to: associate the welding-type data with the first welding job when the first welding job is selected and the second welding job when the second welding job is selected; and store in memory the welding-type data associated with the first welding job when the first welding job is selected and store in memory the welding-type data associated with the second welding job when the second welding job is selected.

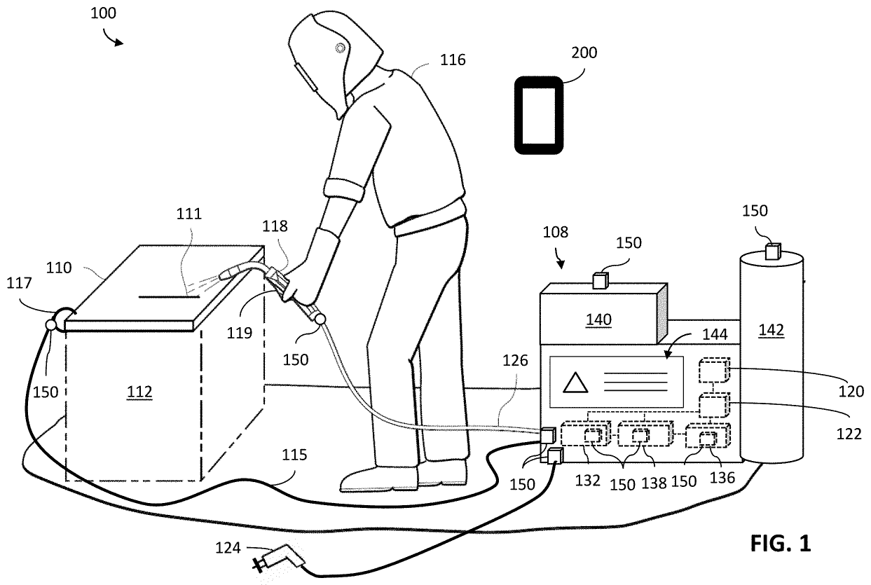

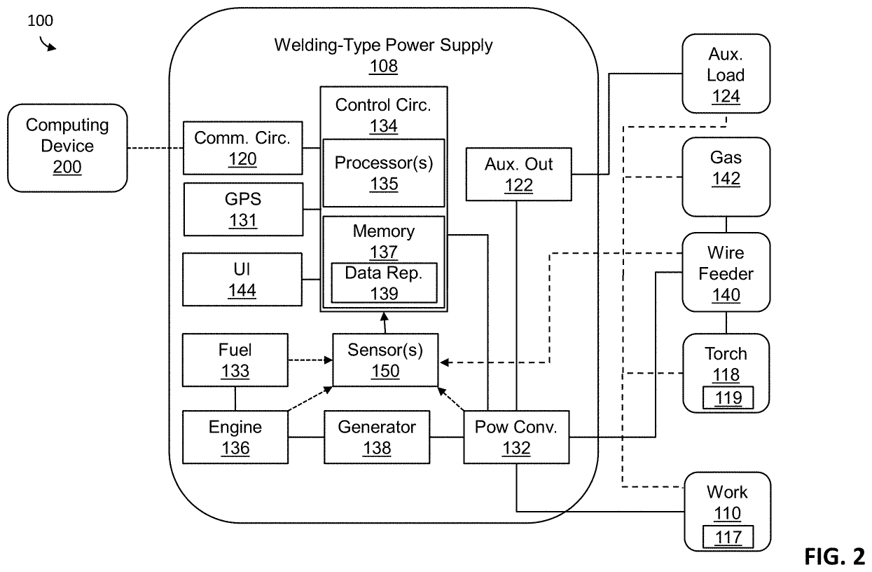

FIG. 1 shows an example welding system 100 that includes a welding-type power supply 108 which monitors welding-type data. FIG. 2 is a block diagram of the welding system 100 of FIG. 1.

As shown, the welding system 100 includes a welding torch 118 and work clamp 117 coupled to the welding-type power supply 108. In the example of FIG. 1, an operator 116 is handling the welding torch 118 near a welding bench 112. In some examples, the welding bench 112 may include a fixturing system configured to hold one or more workpiece(s) 110. In some examples, the fixturing system may include one or more work clamps 117 (e.g., manual and/or pneumatic clamps). In some examples, the workpiece(s) 110 may be independent of a welding bench 112, such as, for example a freestanding element such as a structural steel element, pipeline, or bridge. While a human operator 116 is shown in FIG. 1, in some examples, the operator 116 may be a robot and/or automated welding machine.

In the example of FIGS. 1 and 2, the welding torch 118 is coupled to the welding-type power supply 108 via a welding cable 126. A clamp 117 is also coupled to the welding-type power supply 108 via a clamp cable 115. In some examples, the welding-type power supply 108 includes communications circuitry 120 (e.g., wireless communication circuitry), which may establish communications with an external computing device 200 (e.g., a smartphone, tablet, personal computer, server, cloud-based database, etc.) The communications circuitry 120 may include one or more wireless adapters, wireless cards, cable adapters, wire adapters, dongles, radio frequency (RF) devices, wireless communication devices, Bluetooth devices, IEEE 802.11-compliant devices, WiFi devices, cellular devices, GPS devices, Ethernet ports, network ports, lightning cable ports, cable ports, etc. In some examples, the communication circuitry 120 may be configured to facilitate communication via one or more wired media and/or protocols (e.g., Ethernet cable(s), universal serial bus cable(s), etc.) and/or wireless mediums and/or protocols (e.g., near field communication (NFC), ultra high frequency radio waves (commonly known as Bluetooth), IEEE 802.11x, Zigbee, HART, LTE, Z-Wave, WirelessHD, WiGig, etc.).

In the example of FIGS. 1 and 2, the welding torch 118 is a gun configured for gas metal arc welding (GMAW) and/or flux cored arc welding (FCAW). However, the welding torch 118 may be exchanged for an electrode holder (i.e., stinger) configured for shielded metal arc welding (SMAW), a torch and/or filler rod configured for gas tungsten arc welding (GTAW), a plasma torch for plasma cutting, a gouging torch for gouging, and/or any other welding-type torch for a welding-type operation. In some examples, the welding torch 118 may additionally, or alternatively, include a filler rod. In the example of FIG. 1, the welding torch 118 includes a trigger 119. The trigger 119 is activated by the operator 116 to trigger a welding-type operation (e.g., arc).

In the example of FIGS. 1 and 2, the welding-type power supply 108 includes (and/or is coupled to) a wire feeder 140. The wire feeder 140 houses a wire spool that is used to provide the welding torch 118 with a wire electrode (e.g., solid wire, cored wire, coated wire). The example wire feeder 140 further includes motorized rollers configured to feed the wire electrode to the torch 118 (e.g., from the spool) and/or retract the wire electrode from the torch 118 (e.g., back to the spool).

In the example of FIGS. 1 and 2, the welding-type power supply 108 also includes (and/or is coupled to) a gas supply 142. The gas supply 142 supplies a shielding gas and/or shielding gas mixtures to the welding torch 118 (e.g., via cable 126). A shielding gas, as used herein, may refer to any gas (e.g., CO2, argon) or mixture of gases that may be provided to the arc and/or weld pool in order to provide a particular local atmosphere (e.g., shield the arc, improve arc stability, limit the formation of metal oxides, improve wetting of the metal surfaces, alter the chemistry of the weld deposit, and so forth).

In the example of FIGS. 1 and 2, the welding-type power supply 108 also includes a user interface 144. In some examples, an operator 116 or other user may provide input to, and/or receive output from, the welding-type power supply 108 via the user interface 144. In the example of FIGS. 1 and 2, the user interface 144 comprises one or more adjustable inputs (e.g., knobs, buttons, switches, keys, etc.) and/or outputs (e.g., display screens, lights, speakers, etc.) on the welding-type power supply 108. In some examples, the user interface 144 includes a remote control and/or pendant. The operator 116 may use the user interface 144 to enter and/or select one or more weld parameters (e.g., voltage, current, gas type, wire feed speed, workpiece material type, filler type, etc.) and/or weld operations for the welding-type power supply 108. In some examples, the user interface 144 further includes one or more receptacles configured for connection to (and/or reception of) one or more external memory devices (e.g., floppy disks, compact discs, digital video disc, flash drive, etc.) or a wired connection to an external computing device 200 via which the communications circuitry 120 may establish communications with the external computing device 200 (e.g., via Ethernet, USB, lightning connector, etc.).

In the example of FIGS. 1 and 2, the welding-type power supply 108 includes power conversion circuitry 132 configured to receive input power (e.g., from mains power, a generator, etc.) and convert the input power to welding-type output power. In some examples, the power conversion circuitry 132 includes circuit elements (e.g., transformers, rectifiers, capacitors, inductors, diodes, transistors, switches, and so forth) capable of converting the input power to output power. In some examples, the power conversion circuitry 132 also includes one or more controllable circuit elements. In some examples, the controllable circuit elements includes circuitry configured to change states (e.g., fire, turn on/off, close/open, etc.) based on one or more control signals. In some examples, the state(s) of the controllable circuit elements may impact the operation of the power conversion circuitry 132, and/or impact characteristics (e.g., current/voltage magnitude, frequency, waveform, etc.) of the output power provided by the power conversion circuitry 132. In some examples, the controllable circuit elements includes, for example, switches, relays, transistors, etc. In examples where the controllable circuit elements comprise transistors, the transistors may comprise any suitable transistors, such as, for example MOSFETs, JFETs, IGBTs, BJTs, etc.

In some examples, the power conversion circuitry 132 is also configured to convert the input power to auxiliary power for auxiliary type loads. Accordingly, the welding-type power supply includes an auxiliary output 122 (e.g., an outlet.) The auxiliary power provided at the auxiliary output 122 may be AC (e.g., 120 Volt or 240 Volt, 60 Hz power), or DC power (E.g., 12 Volt DC, 24 Volt DC, 48 Volt DC) suitable to drive auxiliary loads 124 (e.g., lights, grinding tools, drills, air compressors, impact wrenches, etc.). In the example of FIG. 1, a grinding tool 124 is connected to the auxiliary output 122 of the welding-type power supply 108.

In the example of FIGS. 1 and 2, the welding-type power supply 108 includes an engine 136 and a generator 138 which converts the mechanical power provided by the engine 136 to electrical power which is provided to the power conversion circuitry 132. The welding-type power supply 108 also includes a fuel reservoir 133 (e.g., a fuel tank) that holds fuel for consumption by the engine 136. In some examples, as explained above, the welding-type power supply 108 may omit an engine and generator and the power conversion circuitry 132 may receive power from another source, such as mains power.

As shown, the welding-type power supply 108 further includes control circuitry 134 electrically coupled to and configured to control the power conversion circuitry 132. In some examples, the control circuitry 134 includes processing circuitry 135 (e.g., one or more processors) as well as analog and/or digital memory circuitry 137. The control circuitry 134 is configured to control the power conversion circuitry 132, so as to ensure the power conversion circuitry 132 generates the appropriate welding-type output power for carrying out the desired welding-type operation.

In some examples, the control circuitry 134 is also electrically coupled to and/or configured to control the wire feeder 140 and/or gas supply 142. In some examples, the control circuitry 134 controls the wire feeder 140 to output wire at a target speed and/or direction. For example, the control circuitry 134 may control the motor of the wire feeder 140 to feed the wire electrode to (and/or retract the wire electrode 250 from) the torch 118 at a target speed. In some examples, the welding-type power supply 108 controls the gas supply 142 to output a target type and/or amount gas. For example, the control circuitry 134 may control a valve in communication with the gas supply 142 to regulate the gas delivered to the welding torch 118.

In some examples, the welding-type power supply 108 includes geo-locating circuitry 131 (see, e.g., FIG. 2), such as a global positioning system (GPS) device 131. Using input received from the GPS device 131, the control circuitry 134 may determine a physical location of the welding-type power supply 108. In some examples, the control circuitry 134 determines the physical location of the welding-type power supply based on a communication network (e.g., a Wi-Fi or wired connection to the internet) to which the communications circuitry 120 is connected (e.g., based on an internet protocol (IP) address of the welding-type power supply 108). For example, the memory 137 may include a look up table or database that associates IP addresses (or portions of IP addresses) with physical locations.

In the example of FIGS. 1 and 2, the welding system 100 further includes several sensors 150. In some examples, the sensors 150 may be configured to sense, detect, and/or measure various welding-type data of the welding system 100. For example, the sensors 150 may sense, detect, and/or measure a voltage and/or current of the power received by the welding-type power supply 108, power conversion circuitry 132, and/or welding torch, and/or the voltage and/or current of the power output by the welding-type power supply 108 and/or power conversion circuitry 132. As another example, the sensors 150 may sense, detect, and/or measure a velocity (e.g., speed and/or feed direction) of the wire feeder 140 and/or type of wire being fed by the wire feeder 140. As another example, the sensors 150 may sense, detect, and/or measure a gas type and/or gas flow (e.g., through a valve) from the gas supply 142 to the welding torch 118. As another example, the sensors 150 may sense, detect, and/or measure a trigger signal (e.g., pull, release, etc.) of the welding torch 118, and/or a clamping signal (e.g., clamp, unclamp, etc.) of the clamp 117. As another example, the sensors 150 may sense, detect, and/or measure a fuel consumption, engine speed, or engine hours of the engine 136. Additionally or alternatively, the sensors 150 may sense, detect, and/or measure data associated with the auxiliary output and or auxiliary load. For example, the sensors may sense total time auxiliary power is provided to the auxiliary load and/or an amount of energy provided to the auxiliary load. In some examples, the control circuitry 134 is in communication with the sensors 150 and/or otherwise configured to receive information from the sensors 150.

In some examples, a welding operation (and/or welding process) is initiated when the operator 116 activates the trigger 119 of the welding torch 118 (and/or otherwise activates the welding torch 118). During the welding operation, the welding-type power provided by the welding-type power supply 108 is applied to the electrode (e.g., wire electrode) of the welding torch 118 in order to produce a welding arc between the electrode and the one or more workpieces 110. The heat of the arc may melt portions of a filler material (e.g., wire) and/or workpiece 110, thereby creating a molten weld pool. Movement of the welding torch 118 (e.g., by the operator 116) may move the weld pool, creating one or more welds 111.

When the welding operation is finished, the operator 116 may release the trigger 119 (and/or otherwise deactivate the welding torch 118). In some examples, the control circuitry 134 detects that the welding operation has finished. For example, the control circuitry 134 may detect a trigger release signal via sensor 150. As another example, the control circuitry 134 may receive a torch deactivation command via the user interface 144 (e.g., where the torch 118 is maneuvered by a robot and/or automated welding machine). As another example, the control circuitry 134 may detect via sensors 150 the striking of a welding arc and/or the duration of a welding arc.

In some examples, the control circuitry 134 detects (e.g., via sensors 150) certain welding data pertaining to the welding-type power supply 108, clamp 117, bench 112, and/or welding torch 118 during a welding process.

The memory 137 includes a data repository 139 which stores the welding-type data (e.g., welding-type data received from sensors 150, system configuration settings, or other operator provided input). The control circuitry 134 (e.g., processing circuitry 135) is configured to organize the collected welding-type data in the data repository 139 based on associations with particular welding jobs. The data repository 139 may store a plurality of identifiers associated with a plurality of welding jobs. When the welding-type data is collected, the control circuitry 134 associates the collected welding-type data with a selected one of the plurality of welding jobs and then stores and organizes the welding-type data in data repository 139 the based on the associated welding job.

In some examples, a welding job is selected from a plurality of welding jobs via the user interface 144. For example, an operator 116 may select a welding job (e.g., a first welding job) from a plurality of welding jobs stored in the data repository 139 via the user interface 144. Subsequent welding-type data that is collected may then be associated in the data repository 139 with the selected welding job, until a different (e.g., a second) welding job is selected. Welding-type data that is collected after the second welding job is selected is then associated with the second selected welding job in the data repository 139, until another (e.g., the first welding job again or a third welding job) is selected. Accordingly, welding-type data that is collected is stored and organized in the data repository 139 in association with selected welding jobs.

In some examples, the operator may provide names to one or more of the plurality of welding jobs (e.g., “Job A,” “Job B,” “Job C,” etc.) via the user interface 144. In some examples, the operator 116 may manage the plurality of welding jobs stored in the data repository 139 via the user interface 144. For example, the operator 116 may add a new welding job to the plurality of welding jobs stored in the data repository 139. As another example, the operator 116 may delete a welding job from the plurality of welding jobs stored in the data repository 139. In some examples, the operator 116 may reset the welding-type data associated with a particular welding job (e.g., reset one or more (or all) of the collected and stored welding-type data categories associated with the particular welding job).

In some examples, the control circuitry 134 automatically selects a welding job based on the physical location of the welding-type power supply 108. As explained above, in some examples the control circuitry 134 is configured to determine a physical location of the welding-type power supply 108 based on input received from the GPS 131 or based on a communications network to which the communications circuitry 120 is connected. Particular welding jobs may be associated with physical locations in memory 137. For example, an operator 116 may use the welding-type power supply 108 at welding jobs at different physical locations (e.g., a shipbuilding yard, multiple construction sites, etc.). When the control circuitry 134 determines that the physical location of the welding-type power supply 108 is within the physical coordinates (or, for example, within a threshold distance of a particular coordinate) associated in memory 137 with a particular welding job, that particular welding job is automatically selected by the control circuitry 134. The control circuitry 134 may prompt the operator 116 to confirm, via the user interface 144, that the automatically selected job should be used. Subsequent welding-type data that is collected is then associated in the data repository 139 with the automatically selected welding job, until a different welding job is selected, either automatically based on a detected change in location or via operator input. In some examples, an operator 116 may override an automatically selected welding job, for example by selecting a different welding job via the user interface 144.

In some examples, when the welding-type power supply 108 is powered on at a physical location that is not associated with any welding jobs stored in memory, the user interface 144 prompts the operator to either create a new welding job or associate the new physical location with an existing welding job. Subsequently collected welding-type data is then associated and stored in the data repository 139 with the newly created or operator-selected welding job. The memory 137 may also associate the newly created or operator selected welding job with the determined physical location. In some examples, an operator 116 may override the automatically selected welding job by selecting a different welding job, for example via the user interface 144.

In some examples, a welding job is selected from the external computing device 200. The communications circuitry 120 may communicate a list of stored welding jobs in the data repository 139 to the external computing device 200. An operator 116 may then select one of the welding jobs via an interface of the external computing device 200. The selection is then communicated back to the control circuitry 134 via the communications circuitry 120, and subsequently collected welding-type data is then associated and stored in the data repository 139 with the newly created or operator-selected welding job. An operator may also manage the welding jobs and/or the data stored in the data repository 139 in association with the welding jobs via the portable computing device 200, for example in the same way as explained above with reference to the user interface 144.

In some examples, the welding-type power supply 108 may be used by more than one operator 116. The welding job may be automatically selected based on a particular operator. For example, prior to performing any welding-type operations, the welding-type power supply 108 may prompt the operator 116 (e.g., via the user interface 144) to identify himself (e.g., via name or personal identification number). Different operators may use the welding-type power supply 108 for particular jobs, and thus the control circuitry 134 may automatically select a welding job based on the identified operator 116. The data collected during the subsequent welding-operations is then associated and organized in the data repository 139 with the particular selected welding job until a different welding job is selected. After a different welding job is selected, welding-type data that is collected after the different welding job is selected is associated in the data repository 139 with the newly selected welding job.

In some examples, the welding-type data is associated with particular operators 116 (e.g., instead of or in addition to welding jobs). After the operator 116 is identified, subsequently collected welding-type data is then associated in the data repository 139 with the identified operator 116. In some examples, if the operator 116 does not have an entry stored in memory, the user interface 144 may prompt the operator to create a new operator entry. The subsequently collected welding-type data is then associated in the data repository 139 with the newly created operator entry.

In some examples, the control circuitry 134 may automatically select a welding job based on a configuration of the welding-type power supply 108. Particular welding jobs may be associated with particular welding-type power supply 108 configurations 137. For example, particular welding jobs may be associated with particular welding-type processes (e.g., GMAW, SMAW, GTAW, etc.), output voltages/currents, wire feeder settings (e.g., wire feed speed, wire type, etc.), or connections to particular accessory devices (e.g., a connection to a particular type of wire feeder or torch). The control circuitry 134 determines whether the particular configuration of the welding-type power supply 108 is associated in memory 137 with a particular welding job, and if so then that welding job is automatically selected. Subsequent welding-type data that is collected is then associated in the data repository 139 with the automatically selected welding job, until a different welding job is selected. After a different welding job is selected, welding-type data that is collected after the different welding job is selected is associated in the data repository 139 with the newly selected welding job. In some examples, an operator 116 may override an automatically selected welding job, for example by selecting a different welding job via the user interface 144.

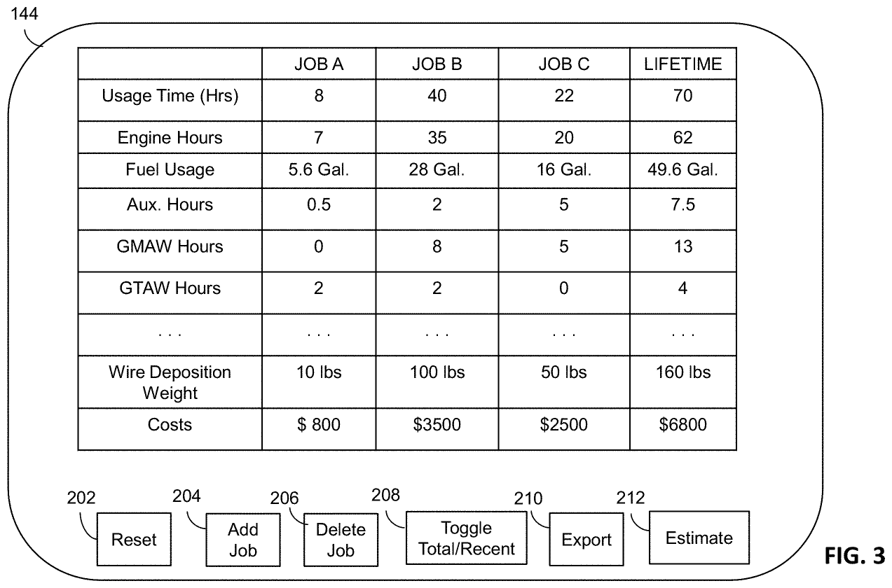

An operator 116 may view the welding-type data associated and stored in the data repository 139, for example via the user interface 144 or an external computing device 200. FIG. 3 is an example display of the user interface 144 which shows example welding-type data stored and/or associated with three welding jobs, Job A, Job B, and Job C. In some examples, the power supply 108 may also track welding-type data over the lifetime of the power supply 108, independent of any welding jobs. In the example of FIG. 3, for instance, the user interface 144 shows LIFETIME welding-type data unassociated with any welding job. While the LIFETIME welding-type data shown in FIG. 3 is equal to the sum of the welding-type data for the three welding jobs (JOB A, JOB B, and JOB C), in some examples, this may not be the case (e.g., if jobs have been deleted and/or reset).

In the example of FIG. 3, the user interface 144 is a touchscreen display. In some examples, welding-type data that may be detected/determined/recorded and subsequently associated with the welding job in the data repository 139 and/or (e.g., displayed) via the user interface 144 includes: an (e.g., average, max, min, etc.) amperage of the power supply 108, a (e.g., average, max, min, total, etc.) voltage of the power supply 108, a (e.g., average, max, min, etc.) wire feed speed of the wire feeder 140, a (e.g., average, max, min) gas flow rate, a shielding gas usage (e.g., volume, weight, etc.), an arc count, an arc time (e.g., hours, minutes, specific dates/times, etc.), a consumable (e.g., wire, fuel, gas, etc.) cost, a consumable cost savings (e.g., amount of money saved), a consumable savings (e.g., an amount of consumable saved), a primary power usage time of the power supply 108 (e.g., hours, minutes, specific dates/times, etc.), a power supply 108 power on time (e.g., hours, minutes, specific dates/times, etc.), an auxiliary power usage time of the power supply 108 (e.g., hours, minutes, specific times, etc.), wire type(s) used, wire deposition weight (in some examples by wire type), associated operator(s), idle/down time of the power supply 108 (e.g., usage time−(primary power usage time +auxiliary power usage time)), welding process type(s), welding process type time (e.g., time and/or specific dates/times configured in each type of welding process), fuel usage (e.g., volume, weight, etc.), (e.g., average, max, min, etc.) engine speed, and/or engine time (e.g., hours, minutes, specific dates/times, etc.). Welding-type data may be sensed, detected, or monitored by sensors 150 as described above and/or may be determined by control circuitry 134 (e.g., welding process, usage time, etc.). In some examples, welding-type data is timestamped by the control circuitry 134 as it is collected and the timestamps are stored in the data repository 139.

In the example of FIG. 3, welding-type data that is displayed includes usage time, engine hours, fuel usage, auxiliary output hours, GMAW process hours, GTAW process hours, wire deposition weight, and cost data. While the welding-type data is shown in a table in the example of FIG. 3, in some examples, the welding-type data may be displayed in a (e.g., bar) graph, and/or in a chart. While discrete numbers are shown in the example of FIG. 3, in some examples, the welding-type data may be depicted with one or more charts and/or graphs showing value(s) over time. In some examples, more welding-type data may be available than may fit on the window of display of the user interface 144 and the operator 116 may scroll through the welding-type data, for example by scrolling up and down. In some examples, more welding jobs may be stored than can be displayed in the window of display of the user interface 144 and the operator 116 may scroll through the welding jobs, for example by scrolling left and right.

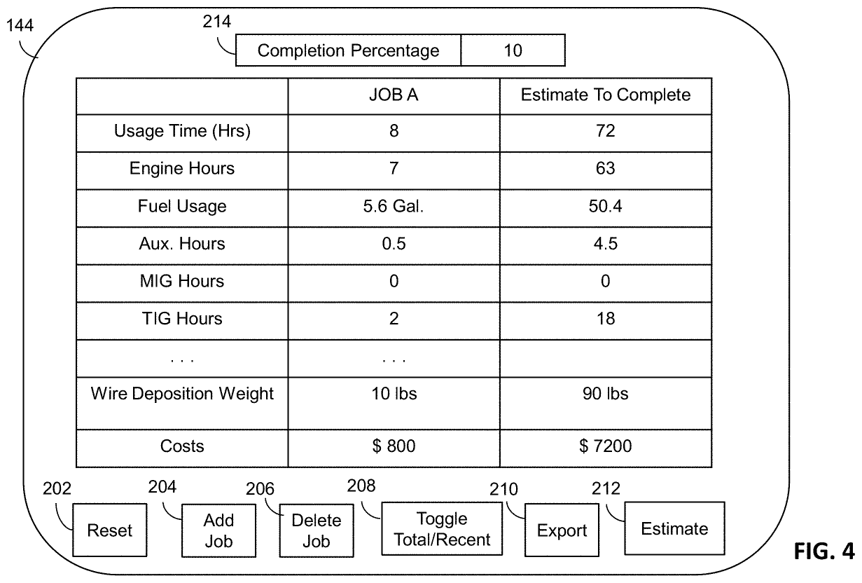

In the example of FIGS. 3 and 4, the user interface 144 also present controls (202, 204, 206, 208, 210, 212) for managing the welding jobs and the welding-type data. For example, to reset the data in a welding job (e.g., set all the stored values of the welding-type data to null) the operator 116 may first select a particular welding job (e.g., Job A, Job B, or Job C), such as, for example, by touching the corresponding position of the particular welding job on the display of the user interface 144, and then touching the reset control 202. As another example, to reset the value of a particular welding-type data field, for example just the wire deposition weight field for Job A, the operator 116 may select the particular welding-type data field by touching the corresponding position of the particular data field on the display of the user interface 144 and then touching the reset control 202. In some examples, data for a particular job or data field may be reset by selecting (e.g., holding down the appropriate button for) that job or data field for a threshold amount of time. In some examples, the welding-type data recorded for the lifetime of the power supply 108 may not be reset.

In the example of FIGS. 3 and 4, the user interface 144 includes an add job control 204 and a delete job control 206. In some examples, an operator 116 may add a new welding job by selecting the add job control 204. In some examples, the operator 116 may provide an identifier for the added welding job, for example by typing the identifier on a keyboard (e.g. a virtual keyboard on the touchscreen display of the user interface 144). In some examples, an operator 116 may also delete a welding job by selecting a particular welding job (e.g., Job A, Job B, or Job C), such as, for example, by touching the corresponding position of the particular welding job on the display of the user interface 144, and then touching the delete job control 206.

In the example of FIGS. 3 and 4, the user interface 144 includes a total/recent toggle control 208. In some examples, via the total/recent toggle control 208, an operator 116 may toggle between seeing (and/or otherwise perceiving) the total accumulated welding-type data for a particular welding job (and/or all welding jobs), and/or seeing only recently accumulated welding-type data for the welding job(s). In some examples, the total/recent toggle control 208 may also toggle between total and/or recently accumulated welding-type data for the lifetime of the welding-type power supply 108.

In some examples, the “total” accumulated welding-type data for a welding job may include the welding-type data accumulated/measured from the time the welding job was first created (or last reset) until the present time. In some examples, the “recently” accumulated welding-type data for a welding job may be a subset (or portion) of the “total” amount. In some examples, the “recently” accumulated welding-type data for a welding job may include the welding-type data accumulated/measured from a defined recent time in the past (e.g., after the welding job was first created or last reset) to the present time.

For example, the defined recent time might be 1 hour ago, 4 hours ago, 8 hours ago, 12 hours ago, 24 hours ago, 48 hours ago, 5 days ago, 7 days ago, one month ago, and/or some other time. In some examples, the defined recent time may be a percentage of the total time the welding job has existed (and/or since last reset). For example, if the welding job was reset 4 days ago, and the defined recent time was 50% of the total time, then toggling to show the recently accumulated welding-type data would show welding-type data accumulated/measured over the past 2 days.

In some examples, the defined recent time may be defined (and/or stored) in the memory circuitry 137 of the welding-type power supply 108. In some examples, the defined recent time may be changed by the operator 116 (e.g., via the user interface). In some examples, the defined recent time may default to a particular value in the absence of input from the operator 116.

In the examples of FIGS. 3 and 4, the user interface 144 includes an export control 210. In some examples, the operator 116 may choose to export welding-type data associated with one or more welding jobs via the export control 210. For example, the welding-type data may be exported to an external memory device (e.g., a flash drive plugged into a USB port of the user interface 144) or to an external computing device 200 via the communications circuitry 120. An operator 116 may select a particular welding job and/or particular welding data associated with a welding job to export. For example, an operator 116 may select to export all of the data associated with Job A, a subset of the data associated with Job A, all of the data associated with Jobs A and B, subsets of the data associated with Jobs A and B, etc. An operator 116 may select which data to export by touching the corresponding position on the display of the user interface 144. The operator 116 then exports the selected data by selecting the export control 210. For example, an operator 116 may select categories of data that may be used for billing (e.g., fuel usage, wire deposition rate, cost data), to present to each client as evidence of costs.

In some examples, particular welding-type data is associated with costs in the data repository 139. For example, an operator 116 may associate particular welding-type data with costs, for example via the user interface, and the association is then stored in in the data repository 139. For example, an operator 116 may associate fuel with a certain cost (e.g., cost per gallon) and wire with another cost (e.g., cost per pound). Then as welding-type data is collected, cost data is automatically calculated based on the collected welding data and the associated costs with the collected welding-type data. In some examples, a particular operator 116 and/or the particular welding-type power supply 108 may be associated with an hourly rate, and cost data may be calculated based on the usage time multiplied by the hourly rates. The cost data may be displayed on the user interface 144, as shown in FIG. 3 and in some examples cost data may be exported as explained above.

In some examples, certain technologies of the power supply 108 may be associated with cost savings. For example, operating certain technologies of the power supply 108 (e.g., electronic fuel injection technologies, Excel Power technologies, Auto Speed technologies, etc.) may save consumable resources (e.g., engine fuel, shielding gas, welding wire, time, etc.). These consumable resources may be associated with a certain cost, as discussed above. Thus, cost savings may be determined based on the saved consumable resource(s) and the associated cost of the consumable resource(s). The cost savings data may also be displayed on the user interface 144 and/or exported, as explained above.

In some examples, the control circuitry 134 may estimate an amount of time, costs, and/or an amount of one or more consumables (e.g., fuel, wire) required to complete a welding job. For example, an operator 116 may initiate an estimate for a particular welding job (e.g., Job A, Job B, or Job C) by touching the corresponding position of the particular welding job on the display of the user interface 144 and then touching the estimate control 212. The user interface 144 then prompts the operator 116 to input a completion percentage of the welding job. For example, as shown in FIG. 4, the operator 116 has input that Job A is ten percent complete into the completion percentage prompt 214. After the operator 116 provides the estimated completion percentage, the control circuitry 134 determines the estimated welding-type date values at the completion of the welding job based on the current welding-type data and the provided completion percentage. The estimate to completion values are then displayed via the user interface 144, as shown in FIG. 4. The estimate to completion values may also be exported. The estimate to completion values may allow an operator 116 to estimate how much time or how much of a particular or multiple consumables (e.g., fuel, wire, shielding gas) will be required to complete a welding job. The estimated completion values may also allow an operator 116 to provide cost estimates, e.g., for billing purposes.

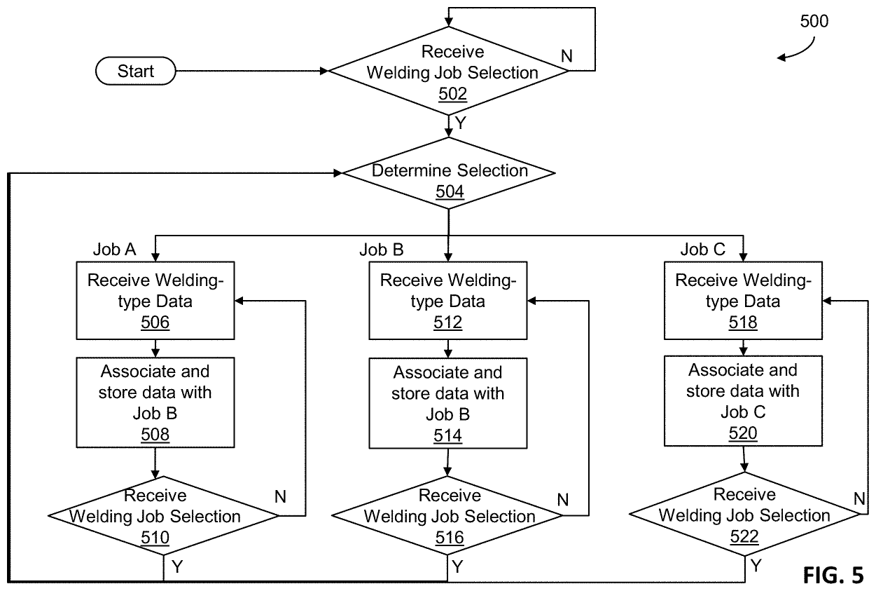

FIG. 5 is a flowchart illustrating an example method 500 for associating welding-type data with a plurality of welding jobs. In some examples, the method 500 may be implemented in machine readable instructions stored in memory 137 of the welding-type power supply 108 and/or executed by the processing circuitry 135 of the welding-type power supply 108.

In the example of FIG. 5, the method 500 begins at block 502. At block 502, the method 500 determines whether a selection of a particular welding job of a plurality of welding jobs stored in the data repository 139 has occurred. In some examples, as explained above, an operator 116 may select a particular welding job via the user interface 144 or via an external computing device 200. In some examples, as explained above, a particular welding job may be selected based on a determined physical location. In some examples, as explained above, a particular welding job may be selected based on an identified operator 116. In some examples, as explained above, a particular welding job may be selected based on a detected configuration of the welding-type power supply. In some examples, a default welding job may be selected if no other welding job selection is made (e.g., within some threshold timeframe and/or by the time welding data is received). In some examples, welding-type data may only be associated with the lifetime of the power supply 108, and not with any particular welding job, if no welding job selection is made.

In the example of FIG. 5, the method 500 continues to monitor for the selection of a welding job at block 502 until a selection is received. If a welding job selection is received, then the method 500 proceeds to block 504. At block 504, the method 500 determines which of the plurality of welding jobs was selected. FIG. 5 illustrates three welding jobs as an example, but any number of selectable welding jobs may be stored in the data repository 139. In some examples, the selection may be to create a new welding job, which is then added to the plurality of welding jobs stored in the data repository 139. In some examples, the selection may be to delete an existing welding job, which is then removed from the plurality of welding jobs stored in the data repository 139

If the method 500 determines that a first welding job (e.g., Job A) was selected (block 504), then the method 500 proceeds to block 506. At block 506, the method 500 monitors for and receives welding-type data (e.g., via sensors 150, system configuration settings, or other operator input). At block 508, the method 500 stores the received welding-type data in the data repository 139 in association with Job A. If Job A already had welding-type data associated with it in the data repository 139, the welding-type data received at block 506 is added to the data that was already stored in the data repository 139. For example, for a fuel usage welding-type data value, the data repository 139 may have already stored 8 gallons of fuel usage associated with Job A. If at block 506, the method 500 receives information that 1 gallon of fuel was used, then at block 508, the 1 gallon of fuel is added to the 8 gallons. Accordingly, the value for fuel usage associated with Job A in the data repository 139 is then updated to 9 gallons.

The method 500 then proceeds to block 510, where the method 500 determines if another welding job selection has been made. If another welding job selection has been made (block 510), then the method 500 returns to block 504 to determine which welding job from the plurality of welding jobs stored in the data repository 139 was selected. If another welding job selection has not been made (block 510), then the method 500 returns to block 506 and continues to monitor for and receive welding-type data, which will be associated with Job A in the data repository 139 at block 508.

If the method 500 determines that a second welding job (e.g., Job B) was selected (block 504), then the method 500 proceeds to block 512. At block 512, the method 500 monitors for and receives welding-type data. At block 514, the method 500 stores the received welding-type data in the data repository 139 in association with Job B. If Job B already had welding-type data associated with it in the data repository 139, the welding-type data received at block 512 is added to the data that was already stored in the data repository 139. For example, for a fuel usage welding-type data value, the data repository 139 may have already stored 8 gallons of fuel usage associated with Job B. If at block 512, the method 500 receives information that 1 gallon of fuel was used, then at block 514, the 1 gallon of fuel is added to the 8 gallons. Accordingly, the value for fuel usage associated with Job B in the data repository 139 is then updated to 9 gallons.

The method 500 then proceeds to block 516, where the method 500 determines if another welding job selection has been made. If another welding job selection has been made (block 516), then the method 500 returns to block 504 to determine which welding job from the plurality of welding jobs stored in the data repository 139 was selected. If another welding job selection has not been made (block 516), then the method 500 returns to block 512 and continues to monitor for and receive welding-type data, which will be associated with Job B in the data repository 139 at block 514.

If the method 500 determines that a third welding job (e.g., Job C) was selected (block 504), then the method 500 proceeds to block 518. At block 518, the method 500 monitors for and receives welding-type data. At block 520 the method 500 stores the received welding-type data in the data repository 139 in association with Job C. If Job C already had welding-type data associated with it in the data repository 139, the welding-type data received at block 518 is added to the data that was already stored in the data repository 139. For example, for a fuel usage welding-type data value, the data repository 139 may have already stored 8 gallons of fuel usage associated with Job C. If at block 518, the method 500 receives information that 1 gallon of fuel was used, then at block 520, the 1 gallon of fuel is added to the 8 gallons. Accordingly, the value for fuel usage associated with Job C in the data repository 139 is then updated to 9 gallons.

The method 500 then proceeds to block 522, where the method 500 determines if another welding job selection has been made. If another welding job selection has been made (block 522), then the processing circuitry 134 returns to block 504 to determine which welding job from the plurality of welding jobs stored in the data repository 139 was selected. If another welding job selection has not been made (block 522), then the method 500 returns to block 518 and continues to monitor for and receive welding-type data, which will be associated with Job C in the data repository 139 at block 520.

Accordingly, as shown and explained with respect to the method 500 of FIG. 5, an operator (or operators of) the welding-type power supply 108 may switch back and forth between a plurality of welding jobs, and welding-type data collected while a particular welding job is selected will be associated with that selected welding job in the data repository 139. As explained above, a welding-type power supply 108 may be used for multiple welding jobs contemporaneously, so it is desirable to track and organize the welding-type data on a welding job basis with the ability to switch back and forth between different welding jobs. Further, as explained above, for example with reference to FIGS. 3 and 4, the welding-type data collected and organized by welding job may displayed and managed (e.g., via the user interface 144 or external computing device 200), and/or exported.

The present method and/or system may be realized in hardware, software, or a combination of hardware and software. The present methods and/or systems may be realized in a centralized fashion in at least one computing system, or in a distributed fashion where different elements are spread across several interconnected computing or cloud systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y) }. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, the terms “control circuit” and “control circuitry,” may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards, that form part or all of a controller, and are used to control a welding process, a device such as a power source or wire feeder, motion, automation, monitoring, air filtration, displays, and/or any other type of welding-related system.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor 130.

The term “power” is used throughout this specification for convenience, but also includes related measures such as energy, current, voltage, and enthalpy. For example, controlling “power” may involve controlling voltage, current, energy, and/or enthalpy, and/or controlling based on “power” may involve controlling based on voltage, current, energy, and/or enthalpy.

As used herein, welding-type power refers to power suitable for welding, cladding, brazing, plasma cutting, induction heating, carbon arc cutting, and/or hot wire welding/preheating (including laser welding and laser cladding), carbon arc cutting or gouging, and/or resistive preheating.

As used herein, a welding-type power supply and/or power source refers to any device capable of, when power is applied thereto, supplying welding, cladding, brazing, plasma cutting, induction heating, laser (including laser welding, laser hybrid, and laser cladding), carbon arc cutting or gouging, and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

As used herein, a welding “job” is a welding session or set of welding sessions associated with a particular task, typically at a specific location. A welding job may include the application of multiple welding-type or auxiliary power-supplied processes (e.g., grinding or other processes run off of an auxiliary power supply). For example, a welding job may be the construction of a vehicle chassis for a large earth mover. As another example, a job might be the construction of the entire earth mover. Other types of welding jobs may involve repair and/or fabrication.

Disabling of circuitry, actuators, and/or other hardware may be done via hardware, software (including firmware), or a combination of hardware and software, and may include physical disconnection, de-energization, and/or a software control that restricts commands from being implemented to activate the circuitry, actuators, and/or other hardware. Similarly, enabling of circuitry, actuators, and/or other hardware may be done via hardware, software (including firmware), or a combination of hardware and software, using the same mechanisms used for disabling.

What is claimed is:

1. A welding-type power supply comprising:
power conversion circuitry configured to receive input power and convert the input power to welding-type power for a welding-type application;
one or more sensors configured to sense welding-type data of the welding-type application; and
processing circuitry configured to:
associate the welding-type data with a first selected welding job of a plurality of welding jobs; and
store in memory the welding-type data associated with the first selected welding job.

2. The welding-type power supply of claim 1, further comprising a user interface configured to enable an operator to select the first selected welding job from the plurality of welding jobs.

3. The welding-type power supply of claim 2, wherein the user interface is configured to enable an operator to apply a unique identifier to each of the plurality of welding jobs.

4. The welding-type power supply of claim 2, wherein the user interface is configured to enable an operator to manage the plurality of welding jobs.

5. The welding-type power supply of claim 2, wherein the user interface is configured to reset the welding-type data associated with the first selected welding job.

6. The welding-type power supply of claim 2, wherein the user interface is configured to enable the operator to select a second selected welding job from the plurality of welding jobs, and wherein the processing circuitry is configured to associate the welding-type data with the second selected welding job after the operator selects the second selected welding job.

7. The welding-type power supply of claim 6, wherein the user interface is configured to enable the operator to subsequently select the first selected welding job from the plurality of welding jobs after the operator selected the second selected welding job, and wherein the processing circuitry is configured to associate the welding-type data with the first selected welding job after the operator subsequently selected the first selected welding job.

8. The welding-type power supply of claim 1, wherein the user interface is configured to display welding-type data associated with each of the plurality of welding jobs.

9. The welding-type power supply of claim 8, wherein the processing circuitry is configured to associate the welding-type data with costs, and wherein the user interface is configured to display costs associated with each of the plurality of welding jobs.

10. The welding-type power supply of claim 1, further comprising communications circuitry configured to communicate with an external computing device, and wherein the communications circuitry is configured to receive a signal indicating a selection of the first selected welding job of the plurality of welding jobs from the external computing device.

11. The welding-type power supply of claim 1, further comprising communications circuitry configured to communicate welding-type data associated with each of the plurality of welding jobs to an external computing device.

12. The welding-type power supply of claim 11, wherein the processing circuitry is configured to associate the welding-type data with costs, and wherein the communications circuitry is configured to communicate the cost data associated with each of the plurality of welding jobs to the external computing device.

13. The welding-type power supply of claim 1, wherein the welding-type data comprises at least one of an amperage of the welding device, a voltage of the welding device, a wire feed speed of the welding device, a shielding gas usage, an arc count, an arc time, a consumable cost, a usage time, a system power on time, an auxiliary power usage time, or a wire deposition weight.

14. The welding-type power supply of claim 1, further comprising an engine and a generator configured to provide electrical power to the power conversion circuitry, wherein the welding-type data comprises a fuel usage.

15. The welding-type power supply of claim 1, further comprising an auxiliary power output, and wherein the welding-type data comprises data associated with the auxiliary power output.

16. The welding-type power supply of claim 1, wherein the first welding job is automatically selected based on a detected location of the welding-type power supply.

17. The welding-type power supply of claim 1, wherein the first welding job is automatically selected based on a detected configuration of the welding-type power supply.

18. The welding-type power supply of claim 1, wherein the first welding job is automatically selected based on the welding-type data.

19. The welding-type power supply of claim 1, wherein the first welding job is automatically selected based on an operator.

20. A welding-type power supply comprising:
power conversion circuitry configured to receive input power and convert the input power to welding-type power for a welding-type application;
one or more sensors configured to sense welding-type data of the welding-type application;
a user interface configured to enable an operator to select a first welding job from a plurality of welding jobs and a second welding job from the plurality of welding jobs; and
processing circuitry configured to:
associate the welding-type data with the first welding job when the first welding job is selected and the second welding job when the second welding job is selected; and
store in memory the welding-type data associated with the first welding job when the first welding job is selected and store in memory the welding-type data associated with the second welding job when the second welding job is selected.
